(19) United States
(12) Patent Application Publication
(10) Pub. No.: US 2005/0008525 A1
(43) Pub. Date: Jan. 13, 2005

(54) Lead-free soft solder

(76) Inventors: Roland Pfarr, Geinhausen/Hailer (DE); Hermann Walter, Geisa (DE); Hermann Wald, Buttlar (DE)

Correspondence Address: WILLIAM COLLARD;COLLARD & ROE, P.C., 1077 NORTHERN BOULEVARD, ROSLYN, NY, 11576, US

(21) Appl. No.: 10/498,154

(22) PCT Filed: Dec. 10, 2002
(86) PCT No.: PCT/DE02/04525

(30) Foreign Application Priority Data
Dec. 15, 2001 (DE) 101 61 826.3

(51) Int. Cl. C22C 13/00

(52) U.S. Cl. 420/560

(57) ABSTRACT

The invention relates to a lead-free soft solder, especially for use in electronic and electrical engineering. The aim of the invention is to provide a lead-free soft solder which does not tend to form coarse tin dentrides, has a smooth and homogeneous surface once melted and is suitable for the use as BGA balls. This aim is achieved by using a lead-free Sn—Ag—Cu solder alloy which comprises a base alloy composed of 5.0 to 20% by weight silver, 0.8 to 1.2 %lt by weight copper, remainder tin and usual impurities. To this base alloy, 0.8 to 1.2% by weight indium and 0.01 to 0.2% by weight nickel, or instead of nickel either 0.01 to 0.2% by weight germanium or 0.01 to 0.2% by weight of one of the elements of the lanthanoids such as for example lanthane or neodym are added. The last-mentioned three variants may be combined with one another or each other in the form of a prealloy in such a manner that the sum thereof is 0.01 to 0.2% by weight.

The invention relates to a lead-free soft solder, particularly for use in electronic and electrical engineering.

The soft solders used in electronic and electrical engineering are supposed to possess not only good wetting behavior with regard to the metallic components to be thermally joined, but also as low as possible an electrical resistance in the seam transition, as well as the greatest possible fatigue limit under reversed stress, so that even materials having very different thermal expansion coefficients can be joined together using these soft solders.

In this connection, it is also of particular importance that the melting points, i.e. melting ranges of the solders lie sufficiently above the maximum operating temperatures, for one thing, but at the same time are so low that the components to be joined by means of soft soldering are not damaged as a result of the melting temperatures required for the joining process using these solders.

Furthermore, it is advantageous for optimal soldering behavior if the alloys used as solders have eutectic properties, i.e. almost eutectic properties.

In the case of solders that are supposed to be used for the production of BGA balls (solder balls for chip production), in particular, not only very good mechanical and electrical properties but also a smooth, homogeneous surface of the solder point are absolutely necessary, so that within the scope of effective quality control of the solder points, these can be easily evaluated optically, without errors, because of their shine.

Therefore there is a very significant demand on these alloys used for the production of BGA balls (solder balls for chip production), in that when the solders cool, dentride formations are supposed to be avoided, since the coarse-grain structure that occurs in connection with the formation of coarse tin dentrides has a very strong detrimental effect on the smooth, homogeneous surface of the solder point and therefore its shine.

Since the solders often form the interface between materials having very different thermal expansion coefficients, shear stresses that occur in connection with the formation of a coarse-grain structure, due to temperature variations, can be caused, which result in damage to the solder connection in connection with the temperature change during cooling after soldering, for example.

All of these very different aforementioned requirements could be met, to the full extent, by the SnPb solders until now.

But since lead is toxic, it is supposed to be banned from electronics in the territory of the European Union as early as by the year 2006, for reasons of protecting workers and the environment.

From U.S. Pat. No. 5,980,822 and U.S. Pat. No. 5,918,795, SnBi solders have become known, for example, which offer themselves as alternatives for SnPb solders, for example, because of their low melting point.

A significant disadvantage of these alloys is that bismuth results in a poor suitability for soldering.

The use of bismuth for lowering the melting point in tin-silver-copper alloys, previously described in EP 0858859, is disadvantageous for use in BGA (ball grid array) balls, since bismuth also increases the ductility and greatly limits the desired elasticity of the solder balls. These solders have low shear strength and low creep strength.

In U.S. Pat. No. 6,231,691 B1, 0.15% Ni is added to a eutectic Sn—4.7% Ag—1.7% Cu solder, previously described according to U.S. Pat. No. 5,527,628, on the one hand.

The eutectic melt temperature of the base solder, at 216.8° C., is not changed thereby.

The copper component used in this solder alloy results in the bridging of relatively broad solder gaps, because of the formation of Cu₃Sn and/or Cu₆Sn₅ needles, but the formation of these intermetallic phases necessarily results in the disadvantages already described with regard to suitability for soldering and the mechanical/physical properties of the solder connection.

Also, a solder alloy with the base solder Sn—4.7% Ag—1.7% Cu and 0.3% Fe is previously described in U.S. Pat. No. 6,231,691 B1. By mixing in the alloy component Fe, the eutectic melt temperature of the base solder, at 216.8° C., which lies close to the melting point of pure Sn (223° C.), is not changed thereby.

However, the addition of 0.3% Fe to the base solder has the result that this solder tends to form rust and therefore cannot be used in the sector of electronics.

Sn—(8.0% to 10%) In—3.2% Ag—1.0% Cu solder alloys are also known from U.S. Pat. No. 5,938,862. However, since indium is available in very limited quantity, in natural deposits, it is about twice as expensive as silver.

This high price of indium therefore has a very strong effect on the price of the solder alloy, because of its large share in the alloy.

At the same time, however, the relatively high indium content also has the result that these In solder alloys are very soft.

At the same time, the indium content has the effect, particularly in connection with use in non-eutectic solder alloys, that deformations (holes) necessarily occur, so that these In solder alloys are necessarily unsuitable for the production of solder balls for chip production.

A number of Sn—(2.0% to 4%) Ag—(0.5% to 1.5%) Cu solder alloys are known from the state of the art, as previously described, for example, in EP 1231015.

These solder alloys have in common that during the technological cooling process, they strongly tend to form coarse tin dentrides, and they are therefore subject to the disadvantages resulting from this.

Another solder alloy is described in EP 0847829, the solder variants of which also tend to form coarse tin dentrides, and which furthermore do not by any means reach the melting and solidification range of 214° C.-215° C. that is optimal for use as BGA balls.

The invention is therefore based on the task of eliminating the disadvantages of the state of the art, and of developing a lead-free soft solder whose melting and solidification range, starting at 214° C., is eutectic, on the one hand, but can be expanded upward in defined manner, by means of targeted doping, on the other hand, and, at the same time, does not in any way tend to form coarse tin dentrides, guarantees a smooth and homogeneous surface of the solder after melting, is also characterized by very good physical and chemical properties such as very good wettability, a high creep strength, good corrosion resistance, good plasticity and impact strength, as well as a low electrical resistance, and is suitable for use as BGA balls (solder balls for chip production).

According to the invention, this task is accomplished by means of a lead-free Sn—Ag—Cu solder alloy, which is characterized in that it consists of a base alloy with 5 to 20 weight-% silver, 0.8 to 1.2 weight-% copper, the remainder tin and the usual contaminants, whereby 0.8 to 1.2 weight-% indium and
in a first variant, from 0.01 to 0.2 weight-% nickel,
in a second variant, from 0.01 to 0.2 weight-% germanium,
and in a third variant, from 0.01 to 0.2 weight-% of an element of the lanthanoids, such as lanthane or neodym,
   are always alloyed with the base alloy, whereby the latter three variants mentioned can also be combined among and with one another in the form of pre-alloys, in such a manner that their sum amounts to 0.01 to 0.2 weight-%.

The lead-free soft solder obtained according to the invention, with a silver share of 5 to 5.5 weight-%, has an almost eutectic melting and solidification temperature in the range of a maximum of 214° C. to 215° C., avoids the formation of coarse tin dentrides when cooling, and guarantees a smooth and homogeneous surface of the solder.

If the doping of silver is increased to more than 5.5 weight-% to 20 weight-%, then with an increasing silver content, a melt range that can be expanded upward in defined manner occurs, starting with the eutectic temperature of 214° C. to 215° C.

These solders according to the invention, having a melt and solidification temperature beginning at 214° C. to 215° C., which can be expanded upward in defined manner and is almost eutectic, avoid the formation of coarse tin dentrides during cooling, and always guarantee a smooth and homogeneous surface of the solder point.

At the same time, the lead-free soft solder according to the invention is characterized by very good physical and chemical properties, such as very good wettability, a high fatigue limit under reversed stress, good corrosion resistance, good plasticity and impact strength, as well as a low electrical resistance and a smooth and homogeneous surface of the solder after melting.

Because of these properties, as described, the lead-free solder according to the invention is particularly suitable for the production of BGA balls (solder balls for chip production).

Other characteristics, details, and advantages of the invention are evident not only from the text of the claims but also from the following explanations of the exemplary embodiment.

The invention will now be explained in greater detail in connection with two exemplary embodiments.

In a first exemplary embodiment, a lead-free soft solder according to the invention, consisting of 98.8 weight-% of an Sn—5% Ag—1% Cu alloy, and 1 weight-% indium with 0.2 weight-% nickel, will be described in greater detail.

In this connection, the addition, according to the invention, of 1 weight-% indium particularly improves those physical properties of the base solder Sn—5% Ag—1% Cu such as its wettability, its corrosion resistance, its plasticity and impact strength.

At the same time, the addition of indium, according to the invention, reduces the electrical resistance at the seam transition, while guaranteeing almost eutectic properties of the alloy as a whole.

In combination with an additional 0.2% addition of nickel, according to the invention, the desired eutectic properties of the alloy according to the invention are almost completely maintained, because of the overall composition according to the invention. At the same time, the result is achieved that during the technological cooling process of the soft solder alloy according to the invention, no coarse tin dentrides are formed.

In a second exemplary embodiment, a lead-free soft solder according to the invention, consisting of 98.8 weight-% of an Sn—5% Ag—1% Cu alloy, and 1 weight-% indium with a doping of 0.2 weight-% lanthane, will be presented in greater detail.

Again, the addition, according to the invention, of 1 weight-% indium particularly improves those physical properties of the base solder Sn—5% Ag—1% Cu such as its wettability, its corrosion resistance, its plasticity and impact strength.

At the same time, the addition of indium, according to the invention, again reduces the electrical resistance at the seam transition, while guaranteeing almost eutectic properties of the alloy as a whole.

In combination with an additional 0.2% addition of lanthane, which can take place in the form of pure lanthane, but also as a pre-alloy with nickel or germanium, for example, according to the invention, the desired eutectic properties of the alloy according to the invention, as well as its melting point of 214° C. to 215° C., are maintained, because of the overall composition according to the invention.

Again, the result is achieved that during the technological cooling process of the soft solder alloy according to the invention, no coarse tin dentrides are formed.

In comparison with the traditional SnPbAg and SnAgCu solders, this solder according to the invention also has an improved homogeneous surface, an improved oxidation behavior, and clearly improved mechanical properties, so that this solder also can optimally be used for the production of BGA balls.

By means of the solution according to the invention, a lead-free soft solder was presented, whose melting and solidification range, starting at 214° C., is eutectic, on the one hand, but on the other hand can also be expanded upward in defined manner, by means of targeted doping and, at the same time, does not by any means tend to form coarse tin dentrides, guarantees a smooth and homogeneous surface of the solder after melting, is furthermore characterized by very good physical and chemical properties, such as very good wettability, a high fatigue limit under reversed stress, good corrosion resistance, good plasticity and impact strength, and is suitable for use as BGA balls (solder balls for chip production).

1. Lead-free soft solder on the basis of an Sn—Ag—Cu alloy, characterized in that starting from a base alloy with 5.0 to 20 weight-% silver, 0.8 to 1.2 weight-% copper, the remainder tin and the usual contaminants, in each instance, whereby 0.8 to 1.2 weight-% indium and 0.01 to 0.2 weight-% nickel or, in place of the nickel, either 0.01 to 0.2 weight-% germanium, or 0.01 to 0.2 weight-% of an element of the lanthanoids, such as lanthane or neodym, are always alloyed with the base alloy, whereby the latter three variants mentioned can also be combined among and with one another in the form of pre-alloys, in such a manner that their sum amounts to 0.01 to 0.2 weight-%.

2. Lead-free solder according to claim 1, characterized in that starting from a base alloy with 5.0 to 5.5 weight-% silver, 0.8 to 1.2 weight-% copper, the remainder tin and the usual contaminants, in each instance, whereby 0.8 to 1.2 weight-% indium and 0.01 to 0.2 weight-% nickel or, in place of the nickel, either 0.01 to 0.2 weight-% germanium, or 0.01 to 0.2 weight-% of an element of the lanthanoids, such as lanthane or neodym, are always alloyed with the base alloy, whereby the latter three variants mentioned can also be combined among and with one another in the form of pre-alloys, in such a manner that their sum amounts to 0.01 to 0.2 weight-%.
